(19) United States
(12) Patent Application Publication
(10) Pub. No.: US 2016/0004607 A1
(43) Pub. Date: Jan. 7, 2016

(54) INFORMATION PROCESSING APPARATUS AND INFORMATION PROCESSING METHOD

(71) Applicant: FUJITSU LIMITED, Kawasaki-shi (JP)

(72) Inventors: Kyoichi Seki, Inagi (JP); DAISUKE HOSHI, Kawasaki (JP)

(21) Appl. No.: 14/855,468

(22) Filed: Sep. 16, 2015

Related U.S. Application Data
(63) Continuation of application No. PCT/JP2013/057670, filed on Mar. 18, 2013.

(51) Int. Cl. G06F 11/14; G06F 9/445

(52) U.S. Cl. CPC G06F 11/1469; G06F 11/1471; G06F 8/61; G06F 2201/84; G06F 2201/865

(57) ABSTRACT

An information processing apparatus includes a storage unit that stores a location and a file name of a change target file which is changed in a prescribed process, and a processor that executes a process including obtaining and saving the change target file by using the location and the file name of the change target file; conducting the installation; detecting a failure that has occurred during the installation; obtaining progress information which represents progress of the installation, and identifying the prescribed process at occurrence of the failure as a failure time process on the basis of the progress information when the failure has been detected; restoring a file changed in the failure time process by using the saved change target file that corresponds to the changed file; and resuming the installation from a point in time at which the failure time process started.

### CROSS-REFERENCE TO RELATED APPLICATION

This application is a continuation application of International Application PCT/JP2013/057670 filed on Mar. 18, 2013 and designated the U.S., the entire contents of which are incorporated herein by reference.

### FIELD

The embodiments discussed herein are related to a process executed when a failure has occurred while software is being installed.

### BACKGROUND

The initial setting process in a server having an operating system (referred to as an OS hereinafter) preinstalled in it is conducted automatically when the server is turned on for the first time. FIG. 1 illustrates an operation flow of the initial setting process in a server. In the initial setting process, a driver corresponding to application software is installed first (S1001). Next, the application software is installed (S1002), and specific setting for the application software is conducted in accordance with the user's environment (S1003). Thereafter, a final check is conducted in order to confirm whether or not the application software has been installed appropriately (S1004). When a hardware failure, a software error, a power-supply disconnection, etc. has occurred during the initial setting process and the process unexpectedly failed in the middle of the installation (S1005), it is not possible to resume the process from a point in the process because it is not recorded up to which step the process had proceeded appropriately. In such a case, the user has to conduct the installation of the OS again (recovery) (S1006), and such recovery takes a long time.

There is a first technique for reducing a period of time taken for completing the installation of a plurality of pieces of software. This first technique is based on an assumption that a computer is caused to conduct the installation of a plurality of pieces of software successively. Also, this first technique causes a computer to realize a function of conducting setting so that a self program is activated automatically when the OS has been rebooted. Also, the first technique causes a computer to realize a function of recognizing the installation progress of the above plurality of pieces of software and resuming the installation of the plurality of pieces of software from uninstalled pieces of software or from the point of the abnormal termination when the above self program has been activated.

Also, there is a second technique for conducting the reboot of an OS at a high speed. This technique includes a data backup unit for backing up the initialization data of the OS in a main storage unit to an initialization data backup area, and an input/output device control unit for halting/controlling an input/output device connected to an information processing apparatus. Further, the second technique includes a reboot control unit for specifying whether or not the reboot is possible and for causing the control to proceed to a specified address of the OS program, and a data recovering unit for recovering the initial data from the data backup area.

Techniques described in for example Japanese Laid-open Patent Publication No. 2004-302929, Japanese Laid-open Patent Publication No. 11-24936, etc. are known.

### SUMMARY

According to an aspect of the embodiment, an information processing apparatus includes a storage unit that stores a location and a file name of a change target file which is changed in a prescribed process executed in a case when installation of software is conducted; and a processor that executes a process including obtaining and saving the change target file by using the location and the filename of the change target file stored in the storage unit; conducting the installation; detecting a failure that has occurred during the installation; obtaining progress information which represents progress of the installation, and identifying the prescribed process at occurrence of the failure as a failure time process on the basis of the progress information when the failure has been detected; restoring a file changed in the failure time process by using the saved change target file that corresponds to the changed file; and resuming the installation from a point in time at which the failure time process started.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates an operation flow of the initial setting process in a server;

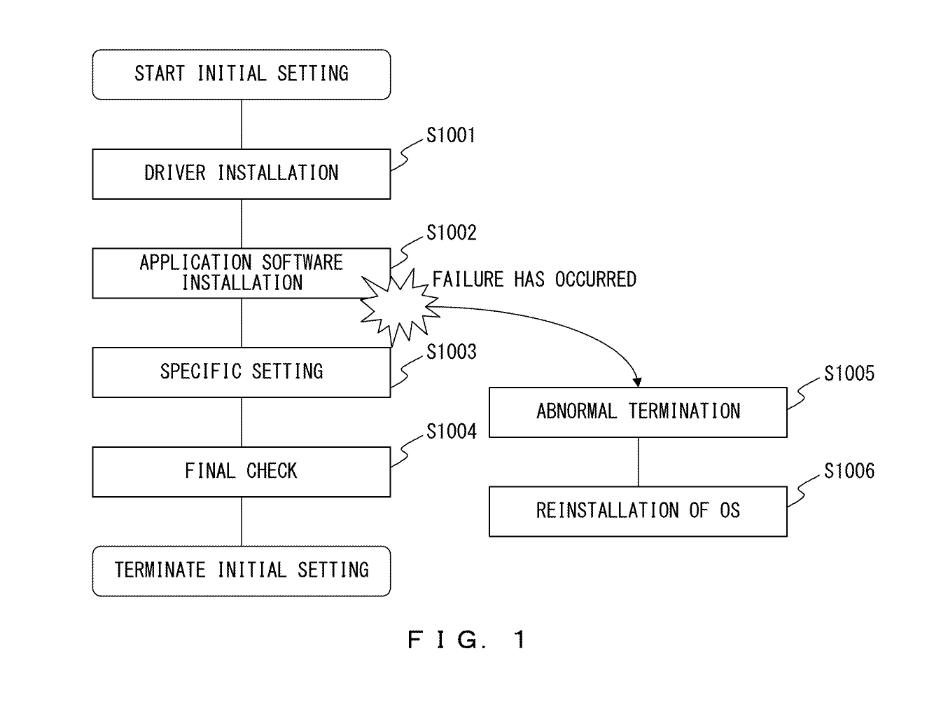

FIG. 2 is an example of a functional block diagram of an information processing apparatus according to the present embodiment;

FIG. 3 illustrates an example of a configuration of the information processing apparatus according to the present embodiment;

FIG. 4 illustrates an example of a progress management table according to the present embodiment;

FIG. 5 illustrates an example of application software change information according to the present embodiment;

FIG. 6 explains backing up of a file conducted by a backup process unit;

FIG. 7 explains the deletion of a file whose file name is described in an addition information list of application software change information;

FIG. 8 illustrates writing back of an installation target file from application environment backup information;

FIG. 9 illustrates a process flow of the entire initial setting process according to the present embodiment;

FIG. 10 illustrates an operation flow of an installation target determination process according to the present embodiment;

FIG. 11 illustrates an operation flow of an application software installation process according to the present embodiment;

FIG. 12 illustrates an operation flow of installing a driver, installing a piece of application software or conducting a specific setting;

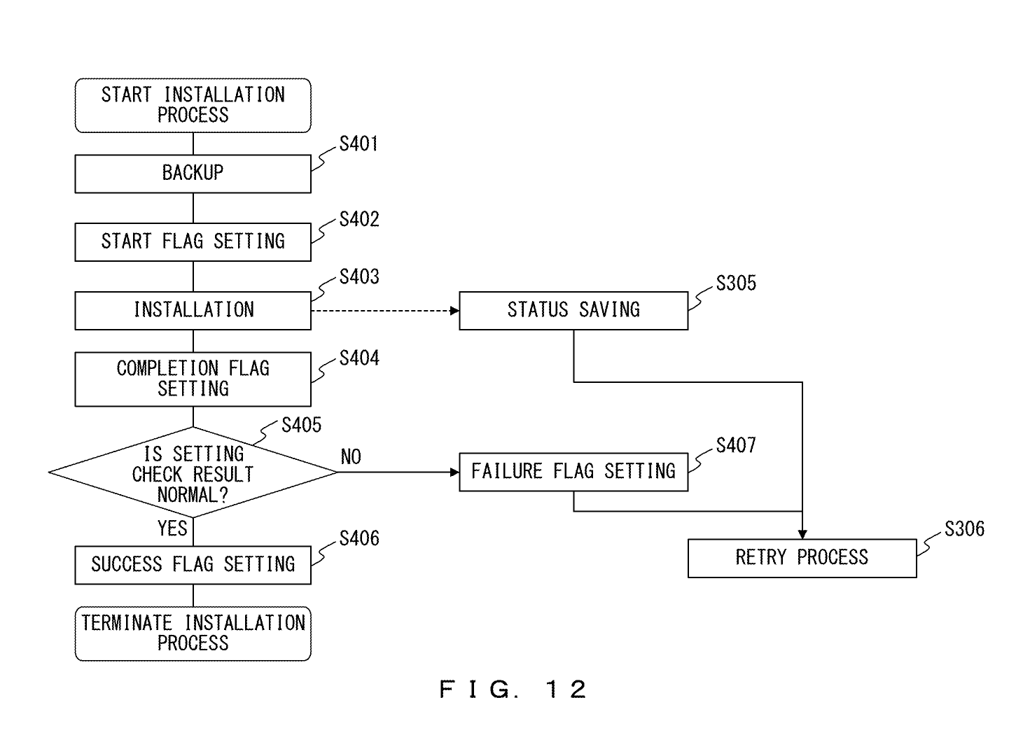

FIG. 13 illustrates an operation flow of a retry process according to the present embodiment;

FIG. 14 illustrates an operation flow of a recovery process according to the present embodiment; and

FIG. 15 illustrates an example of a hardware configuration of the information processing apparatus according to the present embodiment.

### DESCRIPTION OF EMBODIMENTS

According to the first technique, for example, when a power failure has caused power-supply disconnection unexpectedly, it is not possible to record the process status because a correct error process is not conducted. This leads to a situation where the installation is again conducted from the beginning as a process that has not been installed, when the process is to be conducted again.

Further, according to the first and second techniques, the installation process is resumed with the process having already proceeded to a certain point in the installation process. In such a case, since files at the middle of the process remain, it is impossible to resume the installation or even if the installation can be resumed, the successful completion of the installation is not guaranteed. This makes it necessary to manually confirm up to which process the installation had been conducted in a case when the initial setup is to be continued after a problem has occurred, making the operation complicated and leading to a longer period of time for the operation.

Also, according to the second technique, a process time is taken that is as long as a period of time that had elapsed before a failure occurred in the first execution.

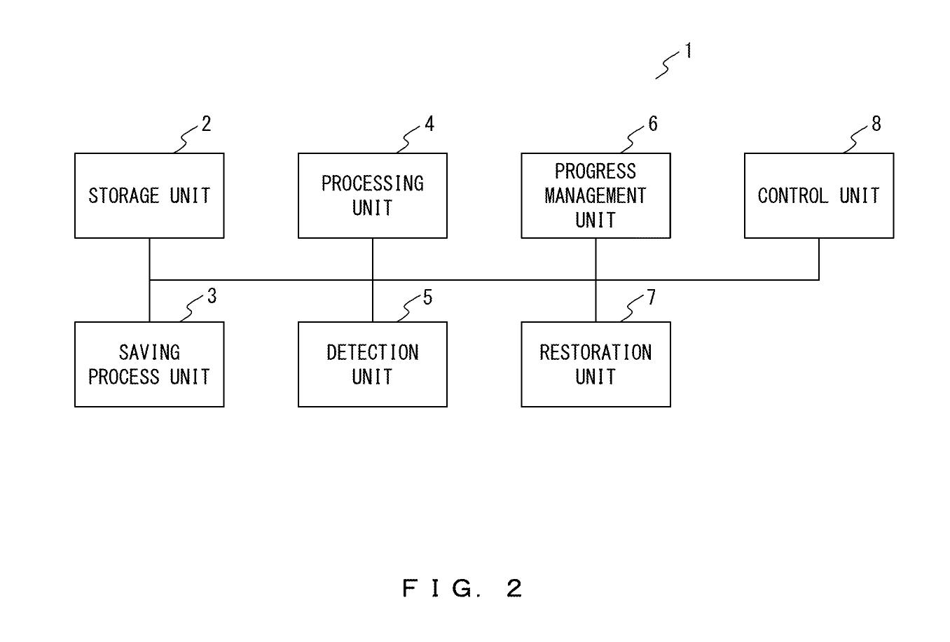

FIG. 2 is an example of a functional block diagram of an information processing apparatus according to the present embodiment. An information processing apparatus 1 includes a storage unit 2, a saving process unit 3, a processing unit 4, a detection unit 5, a progress management unit 6, a restoration unit 7 and a control unit 8.

The storage unit 2 stores the location and the file name of a change target file, which is changed in a prescribed process when a piece of software is installed. Also, the storage unit 2 stores the location and the file name of an addition target file, which is added in a prescribed process. Also, the storage unit 2 stores normal state information, which is information of a case when a prescribed process has been terminated normally.

The saving process unit 3 uses the location and the file name of a change target file stored in the storage unit, and obtains the change target file so as to save it.

The processing unit 4 executes the installation.

The detection unit 5 detects a failure that occurred during installation. The detection unit 5 detects a failure and collects failure information which represents the contents of the failure.

The progress management unit 6 obtains progress information, which represents the progress of installation, and identifies a prescribed process for a case of the occurrence of a failure as a failure time process on the basis of the progress information when a failure has been detected. Also, the progress management unit 6 obtains progress information before and after the prescribed process. Also, the progress management unit 6 determines whether or not the prescribed process has been terminated normally on the basis of the normal state information, and identifies the prescribed process as a failure time process when it has been determined that the prescribed process has not been terminated normally. Also, the progress management unit 6 determines whether or not it is possible to resume the failure time process, on the basis of the failure information, the progress information or the result of the above determination.

The restoration unit 7 restores a file that was changed in a failure time process to a saved change target file that corresponds to the file. Also, the restoration unit 7 deletes a file added in the failure time process on the basis of the location and the file name of an addition target file stored in the storage unit. Also, the restoration unit 7 restores a file changed in the failure time process by using the saved change target file when it has been determined by the progress management unit that to resume the failure time process is not possible.

The control unit 8 resumes the installation from the point in time at which the failure time process started.

According to an information processing apparatus of the present embodiment, it is possible to reduce a period of time needed to resume an installation process of software when a failure has occurred in the process.

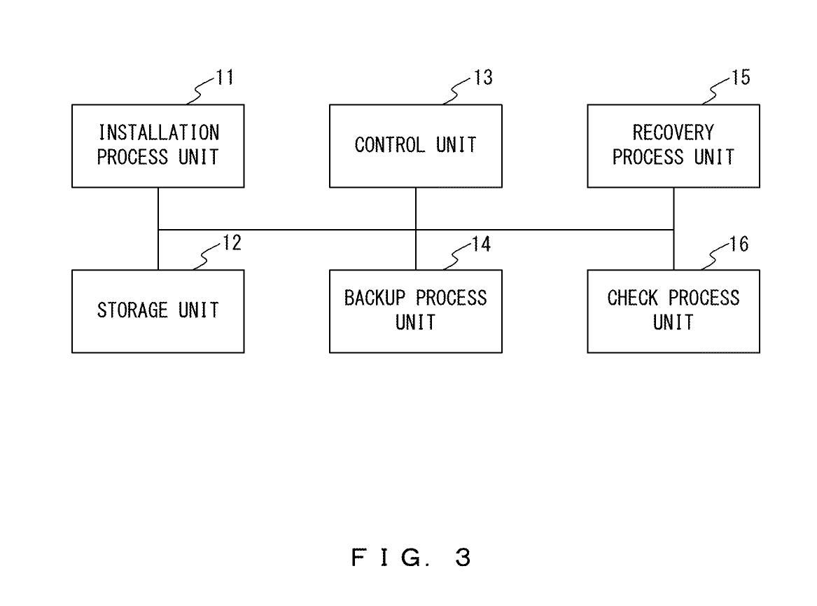

FIG. 3 illustrates an example of a configuration of an information processing apparatus according to the present embodiment. The information processing apparatus 1 according to the present embodiment is for example a server, and includes an installation process unit 11, a storage unit 12, a control unit 13, a backup process unit 14, a recovery process unit 15 and a check process unit 16.

The installation process unit 11 is an example of the processing unit 4 and the detection unit 5. The storage unit 12 is an example of the storage unit 2. The control unit 13 is an example of the progress management unit 6 and the control unit 8. The backup process unit 14 is an example of the saving process unit 3. The recovery process unit 15 is an example of the restoration unit 7. The check process unit 16 is an example of the progress management unit 6.

The installation process unit 11 conducts installation of application software, installation of a driver needed to install that application software, and specific setting for user environments and application software.

Also, the installation process unit 11 detects a failure that has occurred during an installation process, and reports the occurrence of the failure to the control unit 13. In this process, the installation process unit 11 stores, in the storage unit 12, failure information, which is information representing the contents of a failure and the state of the system at the occurrence of the failure, and reports to the check process unit 16 the termination of the storing of the failure information when the storing of the failure information has been terminated.

Further, the installation process unit 11 stores operation information such as a log etc. of the installation process in the storage unit 12.

The storage unit 12 stores a progress management table, which is information for recognizing the progress of an installation process, application software change information, which is a list of pieces of information to be added or changed by each piece of application software, and setting check information, which is information for determining whether or not installation has been conducted normally. Also, in the storage unit 12 an area for saving failure information in case of the occurrence of a failure, an area in which a backup target file is saved by the backup process unit 14, and an area storing operation information of an installation process are secured. Note that the storage unit 12 also stores a file related to a driver and application software to be installed.

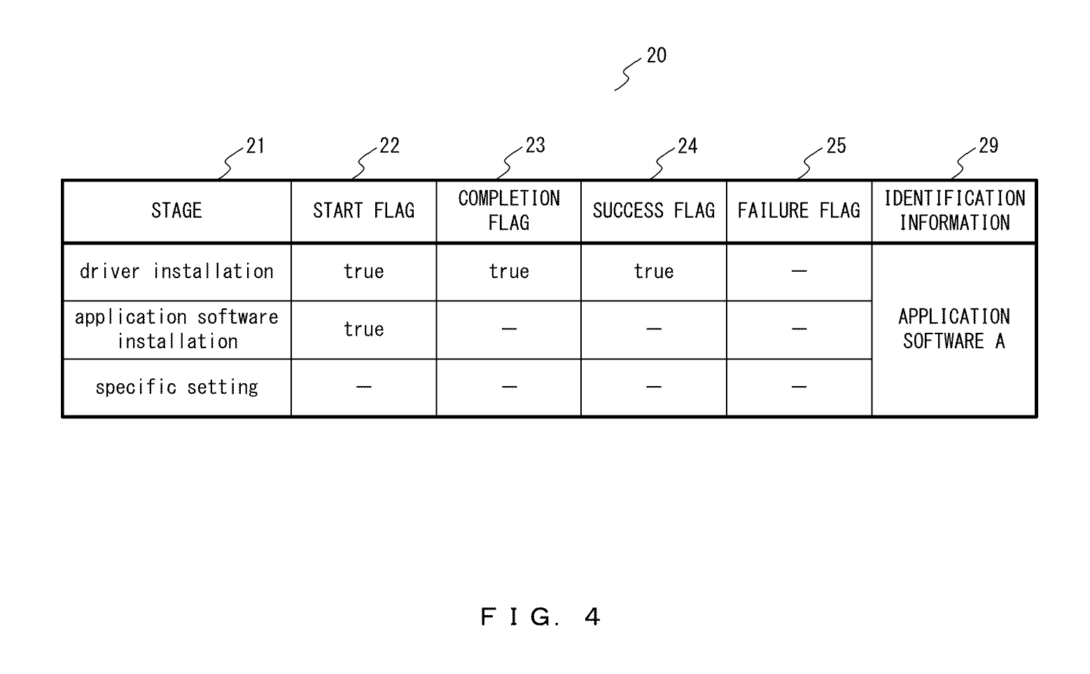

First, explanations will be given for a progress management table. A progress management table is information used for recognizing the progress of an installation process of each piece of application software. A progress management table is generated for each piece of installation-target application software in such a manner that the table is associated with each piece of the application software. FIG. 4 illustrates an example of a progress management table according to the present embodiment. A progress management table 20 includes data items for a stage 21, a start flag 22, a completion flag 23, a success flag 24, a failure flag 25 and identification information 29.

The stages 21 represent steps in a process of installation of one piece of application software. According to the present embodiment, the installation of application software is divided into three steps in accordance with the process contents. The three steps are driver installation, application installation and specific setting. Driver installation is a step in which a driver that is needed by the system in order to install application software is installed. Application installation is a step in which application software itself is installed. Specific setting is a step in which setting items are set in accordance with the user environments after the installation of application software. Note that, steps represented by the stages 21 are not limited to these three steps, and it is also possible to provide for example a setting step etc. before the installation of a driver.

The start flag 22 is a flag representing that a process of the stage 21 has been started. The start flag 22 is set by the control unit 13 immediately before the start of the process of the stage 21.

The completion flag 23 is a flag representing that a process of the stage 21 has been completed. The completion flag 23 is set by the control unit 13 immediately after the completion of the process of the stage 21.

The success flag 24 is a flag representing that a process of the stage 21 has been completed normally. The success flag 24 is set by the control unit 13 when it has been determined that a process of the stage 21 was completed normally. Hereinafter, the determination process of whether or not a process of the stage 21 was completed normally will be referred to as a setting check. A setting check will be explained later in detail.

The failure flag 25 is a flag representing that a process of the stage 21 was not completed normally. The failure flag 25 is set by the control unit 13 when it has been determined that a process of the stage 21 was not conducted normally.

The identification information 29 is information representing which piece of installation target application software the progress management table 20 is associated with.

Next, explanations will be given for application software change information. Application software change information is generated for each process step of the installation of each piece of application software, and is a list of pieces of information that is added/changed in each process. In other words, application software change information is managed for each piece of installation target application software, and is managed for each step of the stage 21.

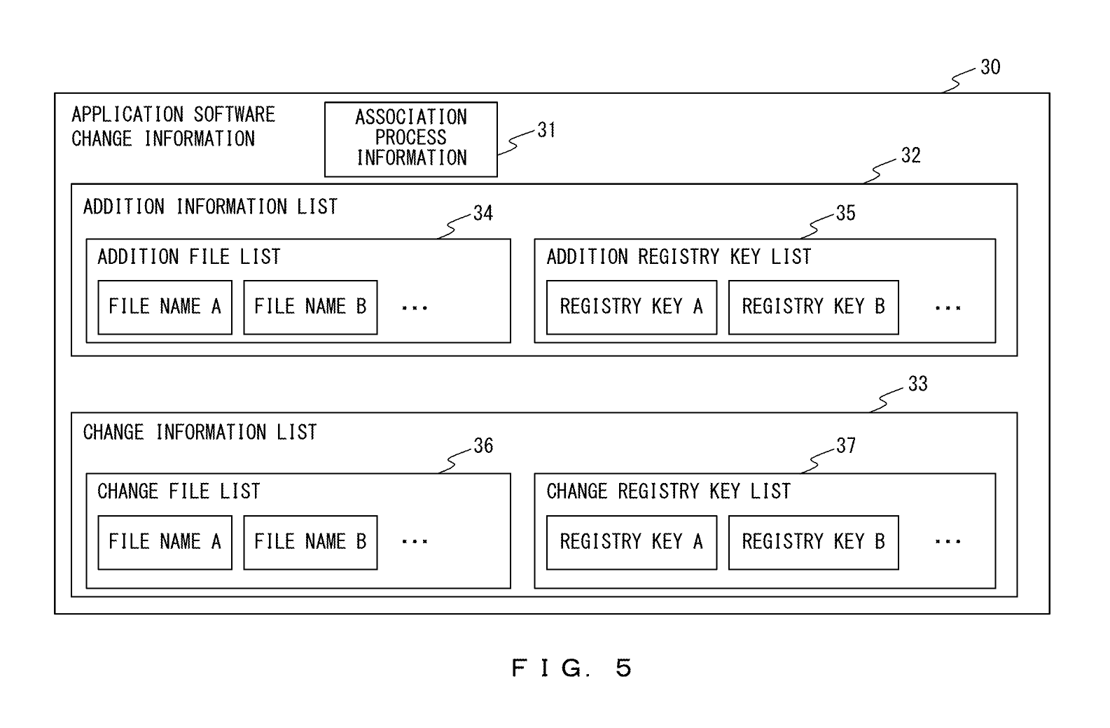

FIG. 5 illustrates an example of application software change information according to the present embodiment. Application software change information 30 includes association process information 31, an addition information list 32 and a change information list 33.

The association process information 31 is information representing which process of the stage 21 in application installation the application software change information 30 is associated with. In the explanations below, a process of the stage 21 specified by the association process information 31 is referred to as a target process.

The addition information list 32 is a list of pieces of information added when a target process is executed. The addition information list 32 includes an addition file list 34 and an addition registry key list 35. Addition file list 34 is a list of the names of files (including folders or directories) that are added in a target process. The names are represented in a form of full paths including location information of the files. The addition registry key list 35 is a list of the names of registry keys added in a target process. Note that in an OS having no registry such as Unix etc., the addition registry key list 35 may be omitted.

The change information list 33 is a list of pieces of information changed when a target process is executed. The change information list 33 includes a change file list 36 and a change registry key list 37. The change file list 36 is a list of the names of files (including folders or directories) that are changed in a target process. The names are represented in a form of full paths including location information of the files. The change registry key list 37 is a list of the names of registry keys changed in a target process. Note that in an OS having no registry such as Unix etc., the change registry key list 37 may be omitted.

Next, explanations will be given for setting check information. Setting check information is information used for determining whether or not a process has been conducted normally in each of the stages 21 for each piece of installation target application software. In setting check information, a setting item that is to have been set when a process has been terminated normally and the value thereof are described.

Note that the application software change information 30 and the setting check information are stored in a server in advance.

The control unit 13 manages progress in an installation process. For this purpose, the control unit 13 saves the status of the progress at a prescribed point in time in each process in an installation process. Further, the control unit 13 conducts, when a failure has occurred, a process of identifying up to which of the stages 21 the process had been completed at the point in time of the occurrence of the failure.

First, explanations will be given for an example of a process in which the control unit 13 saves the status of progress at a prescribed point in time in each process in an installation process. The control unit 13 sets the start flag 22 at the start point in time of the process in each of the stages 21. Also, the control unit 13 sets the completion flag 23 at a completion point in time of the process in each of the stages 21. After setting the completion flag 23, the control unit 13 instructs the check process unit 16 to conduct a setting check. Further, the control unit 13 sets the success flag 24 when it has been determined in the setting check of the stage 21 that a process of the stage 21 was conducted normally. Also, the control unit 13 sets the failure flag 25 when it has been determined in the setting check that a process in the stage 21 is not conducted normally.

Next, explanations will be given for an example in which the control unit 13 identifies up to which of the stages 21 the process had been completed at a point when a failure occurred, in a case when a failure has occurred during an installation process. When a failure has occurred, it is reported by the installation process unit 11 to the control unit 13 that a failure has occurred. Then, the control unit 13 identifies the processes that had been completed by the time of the occurrence of the failure by referring to the progress management table 20.

A case is assumed as an example in which the progress management table 20 at the occurrence of a failure was in the state illustrated in FIG. 20. The control unit 13 refers to the value of the identification information 29 in the progress management table 20, and thereby can identify the installation process of which piece of application software a failure occurred in. In the case of FIG. 4, because “APPLICATION SOFTWARE A” has been set in the identification information 29, the control unit 13 determines that the installation process of application software A was being conducted when the failure occurred. Then, by confirming that the value of the success flag 24 in a record (row) in which the value of stage 21 is “driver installation” has been set to “true”, the control unit 13 can determine that the installation of the driver has been completed normally. Thereafter, by confirming that the value of the start flag 22 in a record in which the value of the stage 21 is “application software installation” has been set to “true”, the control unit 13 can determine that the failure occurred after the start of the installation process of the application software. Further, by confirming that the value of the completion flag 23 of the “application software installation” has not been set in a record of “application software installation”, the control unit 13 can determine that the failure occurred before the completion of the installation of the application software.

After identifying up to which of the stages 21 the process had been completed at the point when the failure occurred, the control unit 13 instructs the installation process unit 11 to resume the installation from the starting point in time of the process that is immediately after the identified point in time.

Before the start of the process of each of the stage 21, the backup process unit 14 backs up one or more files that is changed by the process in that step. The files that are the target of the backup are identified by the backup process unit 14 searching for the application software change information 30 whose value of the association process information 31 is identical to the process in the step to be executed next and referring to the change information list 33 of that application software change information 30.

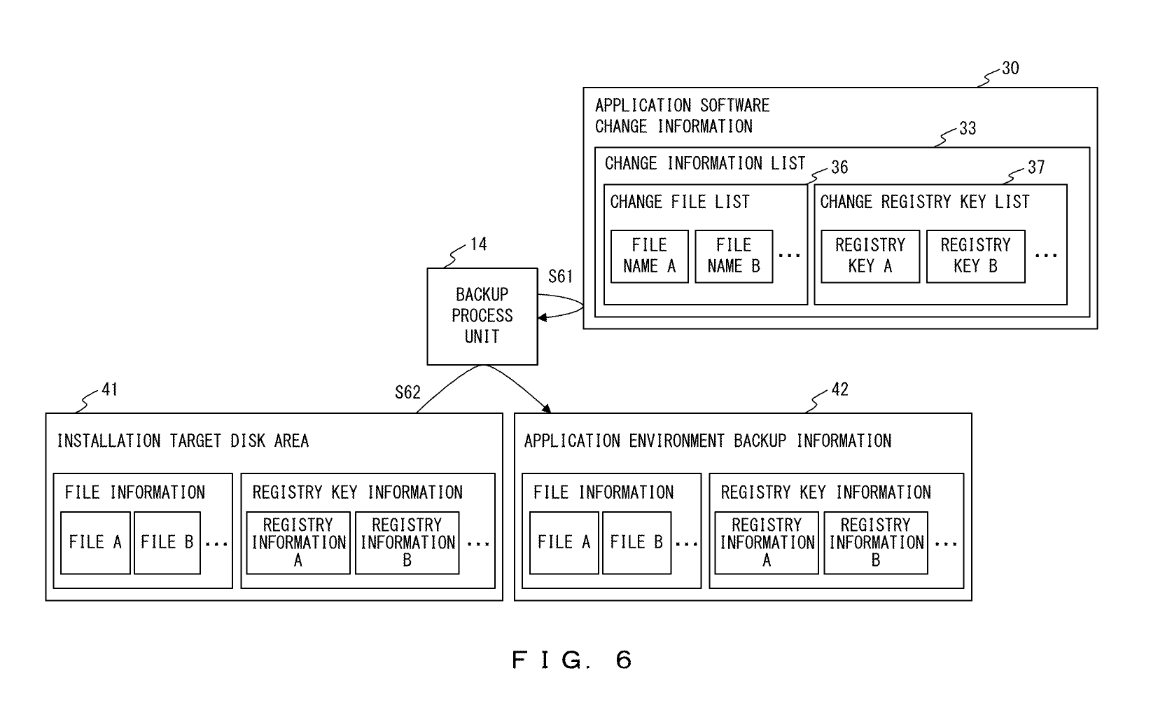

FIG. 6 explains the backing up of files conducted by the backup process unit 14. First, the backup process unit 14 refers to the change file list 36 in the change information list 33, and recognizes the backup target files. Also, the backup process unit 14 refers to the change registry key list 37 of the change information list 33, and recognizes the registry keys of the backup target (step S61). Next, the backup process unit 14 copies the recognized backup target files onto a prescribed backup area. Also, the backup process unit 14 associates the values of the registry keys of the recognized backup targets with the names of the registry keys, and stores them in a prescribed backup area (S62). The file information and the registry key information backed up in this process are referred to as application environment backup information 42.

When a failure has occurred during installation, the recovery process unit 15 recovers the environment of the server to the environment before the start of the each stage 21 before reinstalling the installation target application software. Thereby, a situation is prevented in which the reinstallation fails due to influence of a file, registry information, etc. that remains from the previous installation.

Specifically, when a failure has occurred, the recovery process unit 15 returns the environment of the server to the one at the point in time when the last backup was conducted by the backup process unit 14. Because the backup process unit 14 obtains backup for a process of each stage 21, the point in time when the last backup was conducted is the point in time that is immediately before the start of the process of the stage 21 when the failure occurred.

When a failure has occurred, the recovery process unit 15 receives an instruction to execute recovery from the check process unit 16. Then, the recovery process unit 15 obtains from the control unit 13 information about in which step of what application software the failure occurred. In the explanations below, a process step of application software that was being executed when a failure occurred is referred to as a failure occurrence time process. Note that when an instruction to execute recovery has not been received from the check process unit 16 even when a failure occurred, the recovery process unit 15 does not execute a recovery process. This is for the purpose of making it possible to resume the installation process without executing recovery when the failure that has occurred is determined to be one that does not require recovery, and this point will be described later in detail.

The recovery process unit 15 identifies the application software change information 30 whose value of the association process information 31 represents the failure occurrence time process. Then, the recovery process unit 15 refers to the addition information list 32 of the identified application software change information 30, and deletes one or more files that may have been added in the failure occurrence time process.

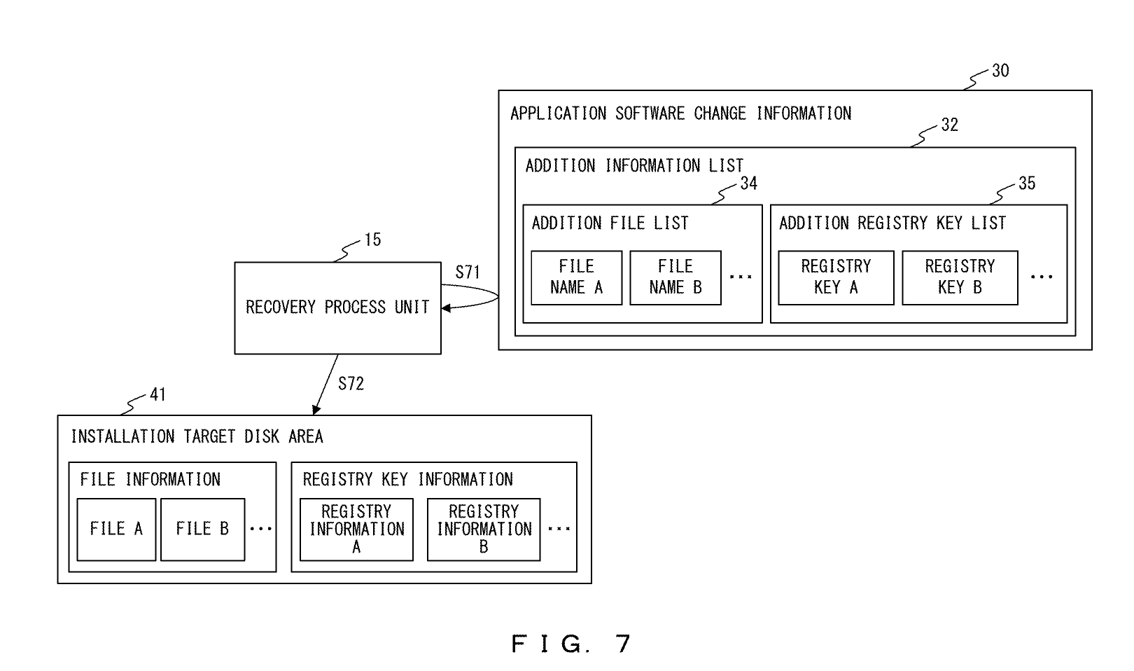

FIG. 7 explains the deletion of files whose file name are described in the addition information list 32 of the application software change information 30. The recovery process unit 15 refers to the addition file list 34 of the addition information list 32, and recognizes deletion target files. Also, the recovery process unit 15 refers to the addition registry key list 35 of the addition information list 32, and recognizes the registry keys of the deletion target (step S71). The recovery process unit 15 deletes all the deletion target files recognized in step S71 from an installation target disk area 41. Also, the recovery process unit 15 deletes all the values of the deletion target registry keys recognized in step S71 (step S72).

Next, the recovery process unit 15 writes one or more target files or one or more target registry keys described in the change information list 33 of the identified application software change information 30 back from the application environment backup information 42.

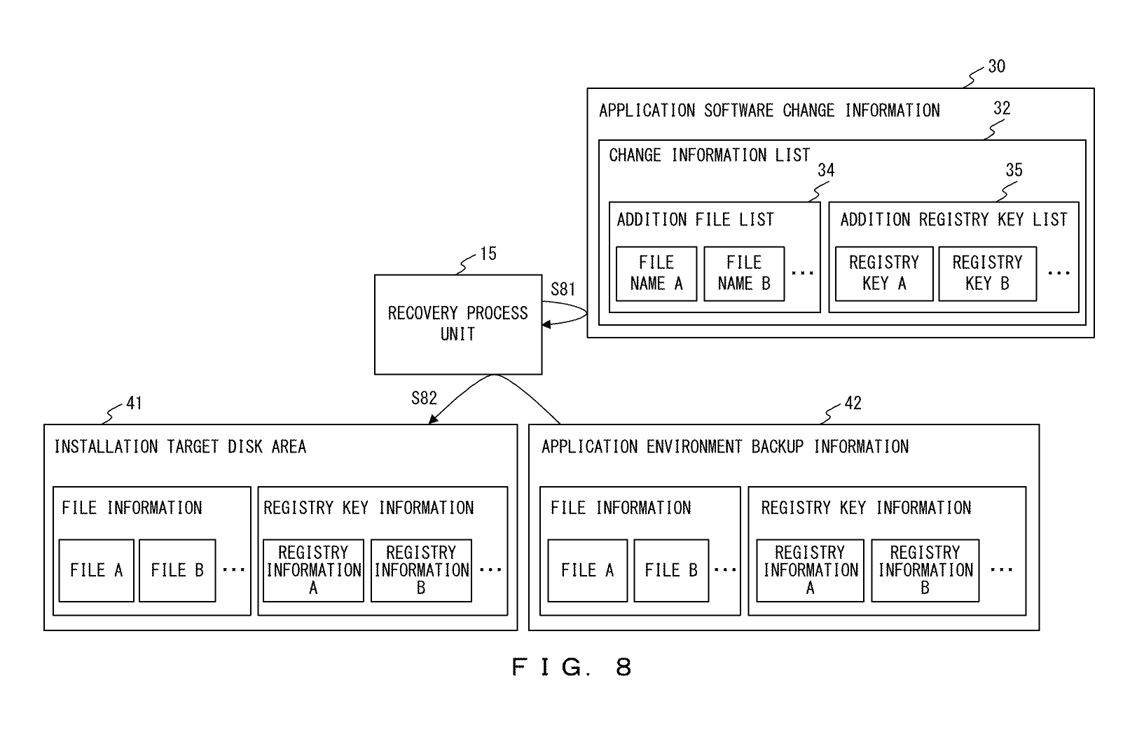

FIG. 8 illustrates the writing back of installation target files from the application environment backup information 42. The recovery process unit 15 recognizes writing-back target files by referring to the change file list 36 of the change information list 33. Also, the recovery process unit 15 refers to the change registry key list 37 of the change information list 33, and recognizes the registry keys of the writing-back target (step S81). The recovery process unit 15 copies the writing-back target files recognized in step S81 from the application environment backup information 42 onto the installation target disk area 41. Also, the recovery process unit 15 sets the registry keys of the writing-back target recognized in step S81 and the value thereof in the registry by referring to the application environment backup information 42 (step S82).

The check process unit 16 conducts a setting check, a system check and a final check.

In a setting check, the check process unit 16 determines whether or not application software has been installed normally. The setting check is started when the check process unit 16 has received an instruction to conduct a setting check from the control unit 13 after the termination of the process of the stage 21. The result of the setting check is reported to the control unit 13.

Specifically, the check process unit 16 refers to setting check information that is for each stage of each piece of application software so as to determine whether or not the values of the setting items described in the setting check information are normal, and thereby determines whether the application software has been installed normally. For example, the check process unit 16 obtains information of the hardware of the server, and checks by using the setting check information whether or not the setting of the application is appropriate for that hardware.

Next, explanations will be given for a system check. In a system check, when a failure has occurred during an installation process, the check process unit 16 determines whether or not it is possible to execute the installation process again without the recovery process unit 15 conducting the recovery. When a failure has occurred, it is first reported from the installation process unit 11 to the check process unit 16 that the storing of failure information has been terminated. Then, the check process unit 16 starts a system check.

Specifically, the check process unit 16 first determines whether or not recovery has already been conducted after the occurrence of the failure. When it has been determined that recovery has already been conducted after the occurrence of the failure, the check process unit 16 determines that recovery is not needed.

When it has been determined that recovery has not been conducted after the occurrence of the failure, the check process unit 16 refers to the failure information saved in the storage unit 12 by the installation process unit 11 at the occurrence of the failure, and determines the contents of the failure that has occurred so as to determine whether or not recovery is unnecessary. This is because in a case where for example the contents of an error are solved with the elapse of a prescribed period of time, the installation process can, in some cases, be executed again without conducting recovery when that period of time has elapsed. In this example, it is also possible to treat the point in time at which the error occurred as the point in time at which to resume the installation process, depending upon the contents of the failure.

When it has been determined from the contents of the failure that recovery is not unnecessary, the check process unit 16 refers to the progress management table 20 so as to determine whether or not recovery is unnecessary. When the start flag 22 has been set and the completion flag 23 has not been set in a prescribed record in the progress management table 20, the check process unit 16 determines that the failure occurred during the process and that recovery is needed. Also, when the failure flag 25 has been set in a prescribed record, the check process unit 16 determines that the installation has not been conducted normally and that recovery is needed. Also, when the start flag 22, the completion flag 23 and the success flag 24 have been set in a prescribed record, the check process unit 16 determines that recovery is not needed.

When it has been determined that recovery is needed in the system check, the check process unit 16 instructs the recovery process unit 15 to execute the recovery process.

Next, explanations will be given for a final check. In a final check, the check process unit 16 obtains for example hardware information and refers to the setting check information or the operation information, and thereby checks whether or not a driver and application software that are to be installed have been installed appropriately and whether or not the specific setting have been conducted appropriately. Also, the check process unit 16 confirms the result of the saving status and the application software change information 30, and thereby checks whether or not the installation of a driver and application software and specific setting have been conducted appropriately. The final check is executed after all the steps of the stages 21 were terminated.

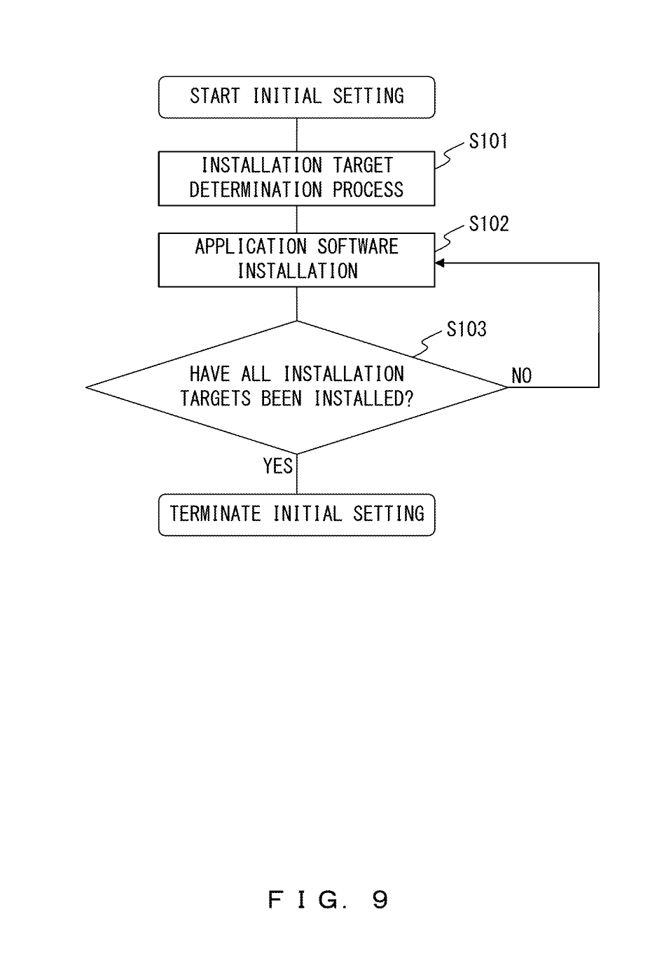

Next, explanations will be given for the operation flow of the present embodiment. In the initial setting process after the completion of the installation of the OS, a plurality of pieces of application software are installed. FIG. 9 illustrates a process flow of the entire initial setting process according to the present embodiment.

In the initial setting process, an installation target determination process is first executed (step S101). The installation target determination process is a process for determining an installation target application software. This process will be described later in detail.

Next, pieces of application software are installed in a prescribed order, targeting the pieces of application software determined in step S101 (S102). Then, the control unit 13 determines whether or not all pieces of application software among the pieces of application software determined in step S101 have been installed (step S103). When it has been determined that not all the pieces of the installation target application software have been installed (NO in step S103), pieces of application software that have not been installed are installed in step S102. When it has been determined that all the pieces of the installation target application software have been installed (YES in step S103), the initial setting process is terminated.

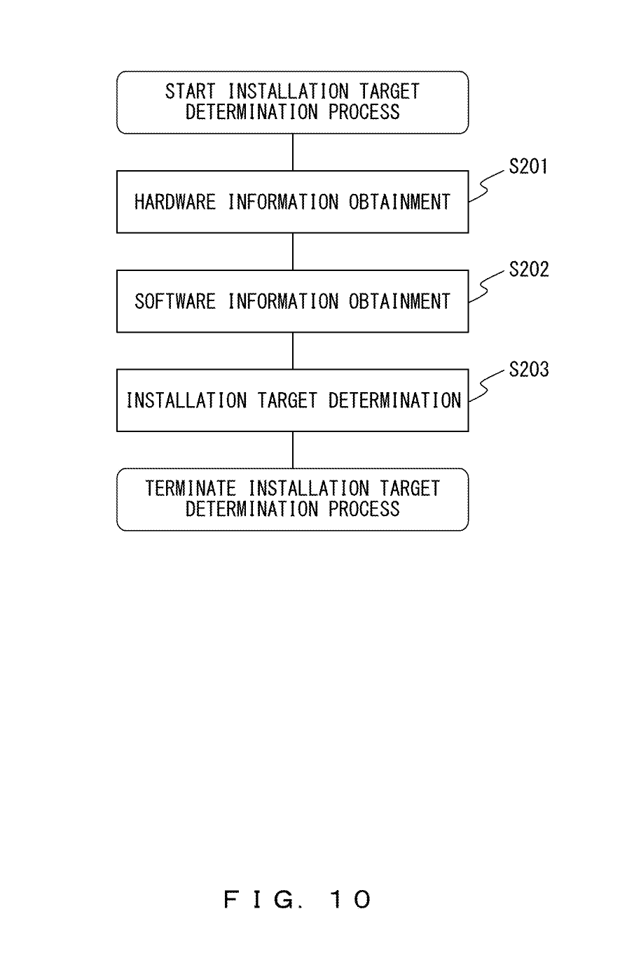

Next, detailed explanations will be given for the installation target determination process. FIG. 10 illustrates an operation flow of the installation target determination process according to the present embodiment.

First, the control unit 13 obtains information of the hardware of the server (step S201). Specifically, the control unit 13 obtains information of the server itself, i.e., information of the CPU (Central Processing Unit), the memories, the devices, the HDD (Hard Disk Drive), etc.

Next, the control unit 13 obtains information of the software of the server (step S202). Specifically, the control unit 13 obtains information of the software installed in the server, compares that information and the application information corresponding to the server itself, and obtains application information for installation.

Next, the control unit 13 determines installation target application software (step S203). Specifically, the control unit 13 identifies apiece of application software that is an installation target on the basis of the hardware information obtained in step S201 and the software information obtained in step S202. The control unit 13 identifies a piece of application software that can be installed on the basis of the hardware information obtained in step S201 from among the pieces of application information obtained in step S202, and determines the identified piece of application software to be the installation target application software. When the installation target application software has been determined, the control unit 13 generates the progress management table 20 for each of the pieces of application software. At that moment, the identification information of the corresponding target application software is set as the identification information 29 in the progress management table 20. When the progress management table 20 is generated, the values for the data items other than the stages 21 and the identification information 29 have not been set. According to the present embodiment, three records respectively having “driver installation”, “application software installation” and “specific setting” as the values for the stages 21 is generated.

Note that the control unit 13 may determine the installation target application software and determine the order of installing the pieces of determined application software by taking into consideration the dependence relationships between the respective pieces of application software. Also, because the stage 21 of each process of each piece of application software is associated with the application software change information 30, the order of installation is determined and the application software change information 30 used by the entire installation process is also determined accompanying the determination of the order of installation.

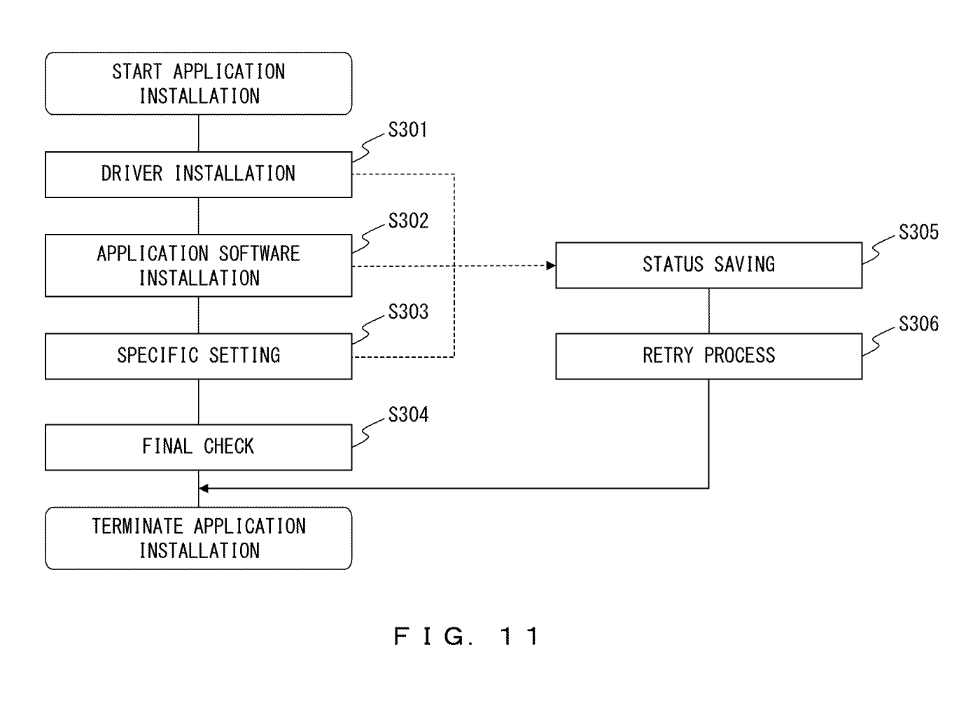

Next, detailed explanations will be given for the installation process of each the pieces of application software (step S102) determined in step S203. FIG. 11 illustrates the operation flow of the application software installation process according to the present embodiment.

First, a driver that is required for the installation of application software is installed (step S301). Then, application software is installed (step S302), and the specific setting is conducted for the application software in accordance with the user's environment (step S303). Then, a final check is conducted by the check process unit 16 for confirming whether or not the application software of the entire system has been installed appropriately, and thereafter the installation of application software is terminated.

When a failure has occurred in step S301 through step S303, the installation process unit 11 detects the failure and saves failure information in the storage unit 12 (step S305). Then, the retry process of the installation is started (step S306). Detailed explanations will be given for the retry process of installation later. When the retry process is terminated, the installation process of application software is terminated.

Next, detailed explanations will be given for the process of installing a driver, (step S301), installing a piece of application software (step S302) and conducting setting specific to a piece of application software (step S303). FIG. illustrates an operation flow of installing a driver, installing a piece of application software or conducting a specific setting.

First, the backup process unit 14 executes the backup process. The backup process unit 14 identifies the backup target file and the registry key from the change information list 33 of the application software change information 30 that is stored in the storage unit 12. Then, the backup process unit 14 copies the information of the backup target file and the registry key from the installation target disk area 41 onto a prescribed backup area as the application environment backup information 42 (S401).

Next, the control unit 13 executes a process of setting the start flag 22 in the progress management table 20 (S402). For example, the control unit 13 stores “true” as the start flag 22 in a record whose value of the stage 21 is identical to the current process step.

Next, when the process step is the installation of a driver, the installation process unit 11 installs the driver, when the process step is the installation of application software, the installation process unit 11 installs the application software, and when the process step is specific setting, the installation process unit 11 conducts specific setting (S403). Note that, as explained in FIG. 11, when a failure has occurred in the process in S403, the control unit 13 saves the status (S305), and the retry process is started (S306).

Next, the control unit 13 executes a process of setting the completion flag 23 in the progress management table 20 (S404). For example, the control unit 13 stores “true” as the completion flag 23 in a record whose value of the stage 21 is identical to the current process step.

Next, the check process unit 16 conducts a setting check of whether or not the process in S403 has been executed normally (S405). When it has been determined in the setting check that the process in S403 was executed normally (YES in S405), the control unit 13 executes a process of setting the success flag 24 in the progress management table 20 (S406). For example, the control unit 13 stores “true” as the success flag 24 in a record whose value of the stage 21 is identical to the current process step.

When it has been determined in the setting check in S405 that the process in S403 was not executed normally (NO in S405), the control unit 13 executes a process of setting the failure flag 25 in the progress management table 20. For example, the control unit 13 stores “true” as the failure flag 25 in a record whose value of the stage 21 is identical to the current process step. Then, the process returns to the retry process in S306.

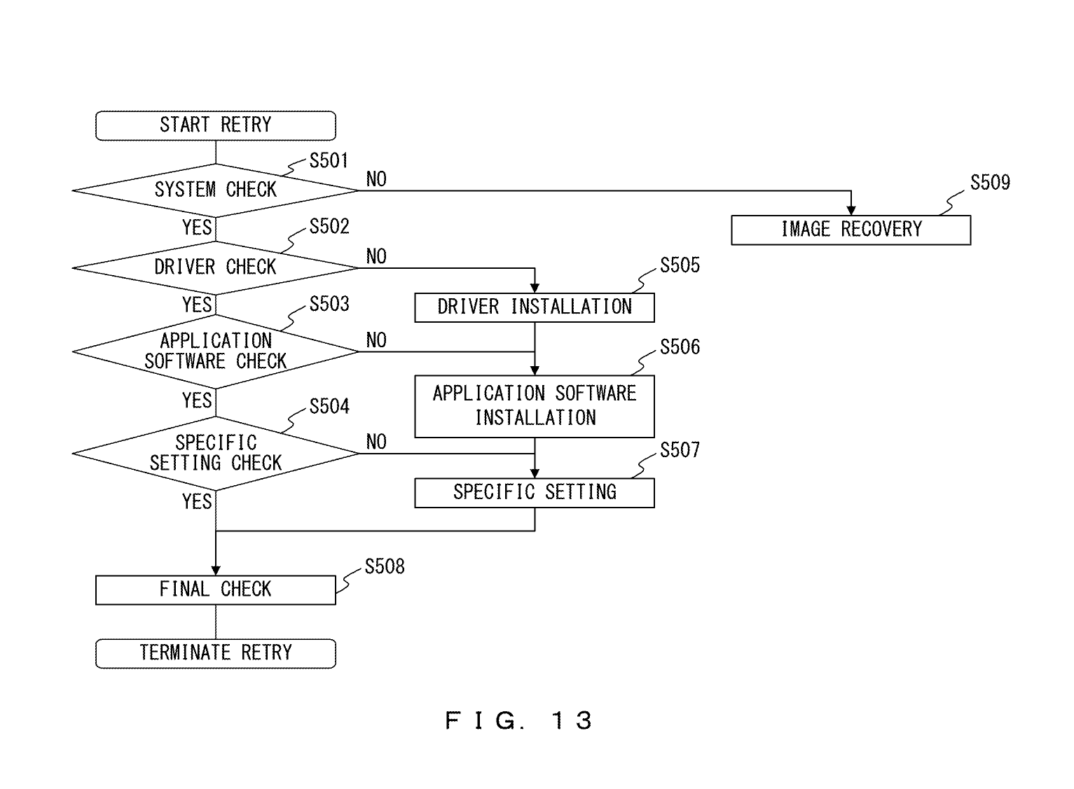

Next, detailed explanations will be given for the retry process (S306). FIG. 13 illustrates the operation flow of the retry process according to the present embodiment.

First, the check process unit 16 conducts the system check so as to determine whether or not it is unnecessary to conduct the recovery process (S501).

When it has been determined that the recovery is unnecessary (YES in S501), the control unit 13 conducts the driver check (S502). In the driver check, it is checked whether or not the installation process of the driver had already been conducted when the failure occurred. The control unit 13 confirms the success flag 24 (or the completion flag 23) in a record whose value of the stage 21 in the progress management table 20 is “driver installation”, and determines whether or not the installation of the driver had been completed. When it has been determined that the installation of the driver had been completed (YES in S502), the process proceeds to S503. When it has been determined that the installation of the driver had not been terminated (NO in S502), the process proceeds to S505.

When it has been determined that the installation of the driver had been completed, the control unit 13 conducts the application software check (S503). In the application software check, it is checked whether or not the installation process of application software had already been conducted when the failure occurred. The control unit 13 confirms the success flag 24 (or the completion flag 23) of a record whose value of the stage 21 in the progress management table 20 is “application software installation” so as to determine whether or not the installation of the application software had been completed. When it has been determined that the installation of the application software had been completed (YES in S503), the process proceeds to S504. When it has been determined that the installation of the application software had not been terminated (NO in S503), the process proceeds to S506.

When it has been determined in S503 that the installation of the application software had been terminated normally, the control unit 13 conducts the specific setting check (S504). In the specific setting check, it is checked whether or not the specific setting process for the application software had already been conducted when the failure occurred. The control unit 13 confirms the success flag 24 (or the completion flag 23) of a record in which the value of the stage 21 is “specific setting” in the progress management table 20 so as to determine whether or not the specific setting had already been completed. When it has been determined that the specific setting had already been completed (YES in S504), the process proceeds to S508. When it has been determined that the specific setting had not been terminated (NO in S504), the process proceeds to S507.

In S505, the installation process unit 11 conducts driver installation. Thereafter, the installation process unit 11 conducts the installation of the application software (S506). Next, the installation process unit 11 conducts specific setting (S507).

Next, the check process unit 16 conducts the final check (S508). The check process unit 16 confirms whether or not a driver and application software that are to be installed have been installed appropriately and whether or not the specific setting has been conducted appropriately. Note that the specific processes in S505, S506, S507 and S508 are similar to those in S301, S302, S303 and S304, respectively.

In S501, when it has been determined that the recovery is necessary (NO in S501), the recovery process is started (S509).

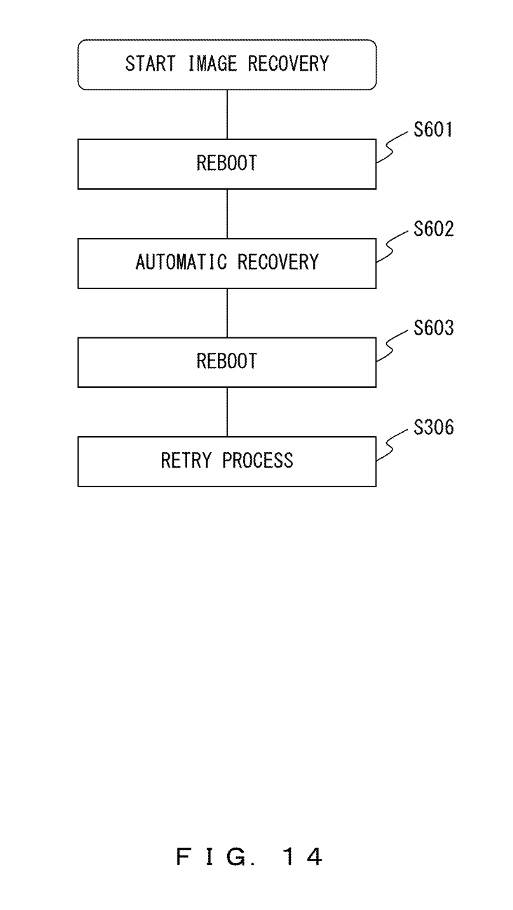

Next, detailed explanations will be given for the recovery process (S509). FIG. 14 illustrates the operation flow of the recovery process according to the present embodiment.

First, the control unit 13 reboots the system (S601). When the reboot has been finished, the control unit 13 identifies up to which of the stages 21 the process had been completed when the failure occurred, and the recovery process unit 15 conducts the recovery process (S602). Then, the control unit 13 reboots the system again (S603). The process proceeds to the retry process (S306).

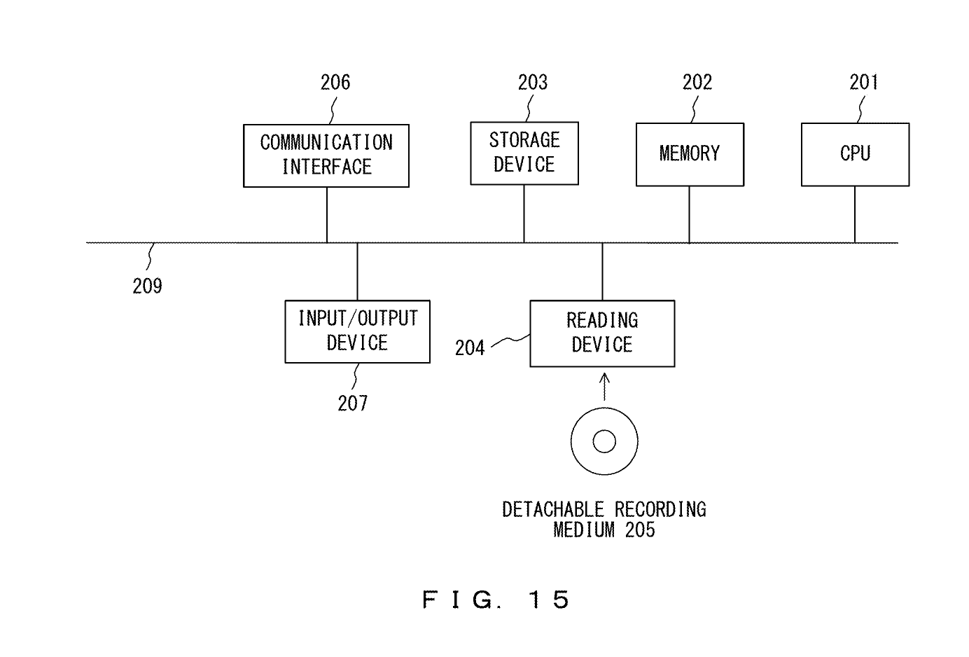

FIG. 15 illustrates an example of a hardware configuration of the information processing apparatus 1 according to the present embodiment. As illustrated in FIG. 15, the server includes a CPU 201, a memory 202 a storage device 203, a reading device 204, a detachable recording medium 205, a communication interface 206 and an input/output device 207. Note that the CPU 201, the memory 202, the storage device 203, the reading device 204, the communication interface 206 and the input/output device 207 are connected to ether other via for example a bus 209.

The CPU (Central Processing Unit) 201 uses the memory 202 so as to execute a program that has described the steps of the above flowcharts. The CPU 201 provides part or all of the functions of the installation process unit 11, the control unit 13, the backup process unit 14, the recovery process unit 15 and the check process unit 16.

The memory 202 is for example a semiconductor memory, and includes a RAM (Random Access Memory) area and a ROM (Read Only Memory) area. The memory 202 provides part or all of the functions of the storage unit 12.

The storage device 203 is for example a hard disk, and provides part or all of the functions of the storage unit 12. The storage device 203 may be a semiconductor memory such as a flash memory etc. Also, the storage device 203 may be an external recording device.

The reading device 204 accesses the detachable recording medium 205 in accordance with an instruction from the CPU 201. The detachable recording medium 205 is implemented by for example a semiconductor device (a USB memory etc.), a medium that information is input to and output from by magnetic effects (a magnetic disk etc.), a medium that information is input to and output from by optical effects (a CD-ROM, a DVD, etc.), etc.

The communication interface 206 transmits and receives data via a network in accordance with an instruction from the CPU 201.

The input/output device 207 corresponds to a device that receives an instruction from for example users.

An information processing program for implementing the embodiment is provided to the server in for example the following forms.

(1) The program has been installed in the storage device 203 in advance.
(2) The program is provided through the detachable recording medium 205.
(3) The program is provided via a network.

Note that the server may employ a configuration including various types of devices. Examples of such devices include a Local Area Network controller and a Video Graphics Array controller.

Note that the present embodiments are not limited to the embodiments described above, and various configurations or various embodiments may be employed without departing from the spirit of the present embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a storage unit that stores a location and a file name of a change target file which is changed in a prescribed process executed in a case when installation of software is conducted; and
a processor that executes a process including:
obtaining and saving the change target file by using the location and the file name of the change target file stored in the storage unit;
conducting the installation;
detecting a failure that has occurred during the installation;
obtaining progress information which represents progress of the installation, and identifying the prescribed process at occurrence of the failure as a failure time process on the basis of the progress information when the failure has been detected;
restoring a file changed in the failure time process by using the saved change target file that corresponds to the changed file; and
resuming the installation from a point in time at which the failure time process started.

2. The information processing apparatus according to claim 1, wherein
the storage unit stores a location and a file name of an addition target file which is added in the prescribed process, and
the restoring deletes a file added in the failure time process on the basis of a location and a file name of an addition target file stored in the storage unit.

3. The information processing apparatus according to claim 1, wherein
the obtaining obtains the progress information before and after the prescribed process.

4. The information processing apparatus according to claim 1, wherein
the storage unit stores normal state information which is information of a case when the prescribed process has been terminated normally, and
the identifying determines whether or not the prescribed process has been terminated normally on the basis of the normal state information, and identifies the prescribed process as a failure time process when it has been determined that the prescribed process has not been terminated normally.

5. The information processing apparatus according to claim 4, wherein
the detecting detects the failure and also collects pieces of failure information which represents contents of the failure,
the determining determines whether or not the failure time process can be resumed on the basis of the failure information, the progress information or a result of the determination, and
the restoring restores a file changed in the failure time process by using the saved change target file when it has been determined that resuming of the failure time process is not possible.

6. An information processing method comprising:
obtaining and saving, by using a computer, a change target file which is changed in a prescribed process executed in a case when installation of software is conducted, by using a location and a file name, stored in a storage unit, of the change target file;
conducting, by using the computer, the installation;
detecting, by using the computer, a failure that has occurred during the installation;
obtaining, by using the computer, progress information, which represents progress of the installation, and identifying the prescribed process at occurrence of the failure as a failure time process on the basis of the progress information when the failure has been detected;
restoring, by using the computer, a file changed in the failure time process by using the saved change target file that corresponds to the changed file; and
resuming, by using the computer, the installation from a point in time at which the failure time process started.

7. The information processing method according to claim 6, wherein
the restoring deletes a file added in the failure time process on the basis of a location and a file name, stored in a storage unit, of an addition target file which is added in the prescribed process.

8. The information processing method according to claim 6, wherein
the obtaining progress information obtains the progress information before and after the prescribed process.

9. The information processing method according to claim 6, wherein
the identifying determines whether or not the prescribed process has been terminated normally on the basis of normal state information which is information of a case when the prescribed process has been terminated normally, and identifies the proscribed process as a failure time process when it has been determined that the prescribed process has not been terminated normally.

10. The information processing method according to claim 9, wherein
the detecting detects the failure and also collecting pieces of failure information which represents contents of the failure;
the determining determines whether or not the failure time process can be resumed on the basis of the failure information, the progress information or a result of the determination; and
the restoring restores a file changed in the failure time process by using the saved change target file when it has been determined that resuming of the failure time process is not possible.

11. A non-transitory computer-readable recording medium having stored therein an information processing program for causing a computer to execute a process comprising:
obtaining and saving a change target file which is changed in a prescribed process executed in a case when installation of software is conducted, by using a location and a file name, stored in a storage unit, of the change target file;
conducting the installation;
detecting a failure that has occurred during the installation;
obtaining progress information, which represents progress of the installation, and identifying the prescribed process at occurrence of the failure as a failure time process on the basis of the progress information when the failure has been detected;
restoring a file changed in the failure time process by using the saved change target file that corresponds to the changed file; and
resuming the installation from a point in time at which the failure time process started.

12. The non-transitory computer-readable recording medium according to claim 11, wherein
the restoring deletes a file added in the failure time process on the basis of a location and a file name, stored in a storage unit, of an addition target file which is added in the prescribed process.

13. The non-transitory computer-readable recording medium according to claim 11, wherein
the obtaining progress information obtains the progress information before and after the prescribed process.

14. The non-transitory computer-readable recording medium according to claim 11, wherein
the identifying determines whether or not the prescribed process has been terminated normally on the basis of normal state information which is information of a case when the prescribed process has been terminated normally, and identifies the proscribed process as a failure time process when it has been determined that the prescribed process has not been terminated normally.

15. The non-transitory computer-readable recording medium according to claim 14, wherein
the detecting detects the failure and also collecting pieces of failure information which represents contents of the failure;
the determining determines whether or not the failure time process can be resumed on the basis of the failure information, the progress information or a result of the determination; and
the restoring restores a file changed in the failure time process by using the saved change target file when it has been determined that resuming of the failure time process is not possible.
